(19) United States
(12) Patent Application Publication
(10) Pub. No.: US 2014/0212859 A1
(43) Pub. Date: Jul. 31, 2014

(54) Focus Object and Method for Use

(71) Applicant: Dustin J. Sagedahl, Hopkins, MN (US)

(72) Inventor: Dustin J. Sagedahl, Hopkins, MN (US)

(21) Appl. No.: 14/165,231

(22) Filed: Jan. 27, 2014

Related U.S. Application Data
(60) Provisional application No. 61/757,798, filed on Jan. 29, 2013.

(51) Int. Cl. A63B 43/00; A63B 69/00; G09B 19/00

(52) U.S. Cl. CPC A63B 43/008; G09B 19/00; A63B 69/00
USPC 434/258; 473/422

(57) ABSTRACT

An object designed to improve the hand-eye coordination of a user. The object comprising a plurality of distinct zones with each zone have a unique indicator. In use a user will verbally identify the indicator prior to catching the object. Preferably, the object is a spherical shaped ball.

### CROSS REFERENCE TO RELATED APPLICATIONS

This application claims the benefit of provisional patent application Ser. No. 61/757,798 filed 2013 Jan. 29 by the present inventor.

### FEDERALLY SPONSORED RESEARCH OR DEVELOPMENT

Not Applicable

### SEQUENCE LISTING, A TABLE, OR A COMPUTER PROGRAM

Not Applicable

### FIELD OF THE INVENTION

The present invention relates to number balls and devices to improve a user's hand-eye coordination.

### BACKGROUND OF THE INVENTION

Often in the participation of athletic and other similar activities individuals are required to have good hand-eye coordination, or as it sometimes called eye-hand coordination. Typically, hand-eye coordination refers to the coordinated control of eye movement with hand movement. Therefore, hand-eye coordination requires the processing of a visual input to guide the hands to a desired movement, such as grasping, catching, reaching, swinging, striking, or grabbing. In a typical movement requiring the use of one's hands, the eyes direct the movement of the hand by providing the location and information about the task such as size, speed, weight, and spin.

In athletics, hand-eye coordination is a skill that is refined through repetition and practice in the desired sport. For example, in catching sports hand-eye coordination is improved through repetitive catching; in sports that require striking or hitting it is improved through repetitive striking of an object. Often the development of hand-eye coordination is not a specific goal but an ancillary result of the repetitive practice involved in athletics.

Since hand-eye coordination is an important part of the success in athletics, it is a skill that is desiring of specific attention and a device to aid in the improvement and development of increased hand-eye coordination. A typical ball is common tool used in the specific development of hand-eye coordination. Often this ball is a standard rubber ball or tennis style ball. Although a ball can provide some aid to the development of hand-eye coordination, it has limitations. Due to these limitations, a ball is desired that is specifically designed to improve a user's hand-eye coordination. Preferably, this ball is easy to use, amenable to several sports and applications, and can be utilized in multiple exercises.

### SUMMARY OF THE INVENTION

An object specifically designed to improve the hand-eye coordination of a user is disclosed. The object is comprised of specific segmented zones with both color indicators and alphanumeric characters. These indicators provide a focal point for a user and aid in the tracking of the ball as it approaches the user.

In the preferred embodiment of the present invention, the object is a spherical ball is divided into six (6) specific zones. Two (2) zones are located at opposed ends of the ball and four (4) zones are equally spaced along the remaining sides of the ball. Each of these individual six (6) zones is colored differently and includes a numeral one (1) through six (6). Although this is the preferred configuration, several alternatives in both the number of zones, displayed characters, and shape of the object are anticipated.

In use a user will interact with the object in an activity and verbally recite a given color, number, or both as the ball approaches. This interaction forces the user to closely focus on the object to properly identify the given indicator. Overtime, repetitive use of the object and the provided method will improve the user's hand-eye coordination.

### BRIEF DESCRIPTION OF THE SEVERAL VIEWS OF THE DRAWING(S)

The accompanying drawings are included to provide a further understanding of the present invention and are incorporated in and constitute a part of this specification. The drawings illustrate exemplary embodiments of the present invention and together with the description serve to further explain the principles of the invention. Other aspects of the invention and the advantages of the invention will be better appreciated as they become better understood by reference to the Detailed Description when considered in conjunction with accompanying drawings, and wherein:

FIG. 1 is a top side view of the ball, according to the present invention;

FIG. 2 is a side view of the ball in direction of the line 2-2 as indicated in FIG. 1, according to the present invention; and

FIG. 3 is a bottom side view of the ball, according to the present invention.

### DETAILED DESCRIPTION OF THE INVENTION

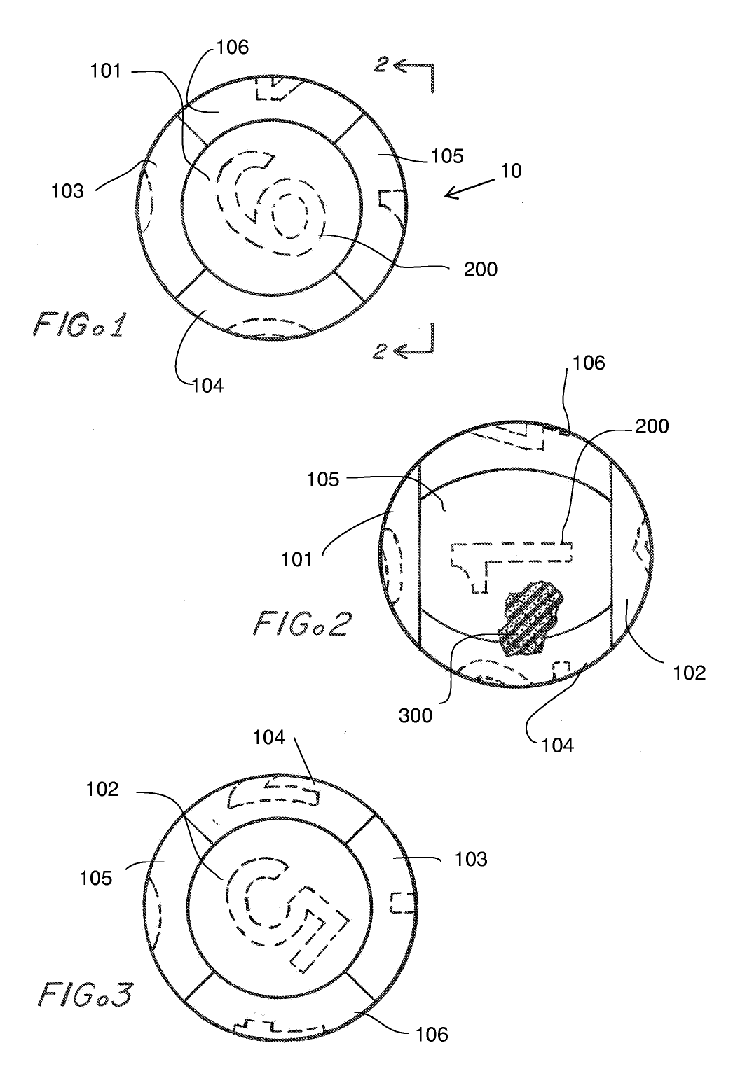

Referring now to FIG. 1-3, various views of an object to improve a user's hand-eye coordination, the object is generally referred to as 10. In the preferred embodiment of the present invention, the object is a ball 10 that is spherical shaped and specifically designed to improve the hand-eye coordination of a user. The ball 10 is comprised of specific segmented zones 100 with indicators 200. These indicators may be any number of things including colors, alphanumeric characters, and pictures. These indicators 200 provide a focal point for a user and aid in the tracking of the ball 10 as it approaches the user. In the preferred embodiment of the present invention, the ball 10 is composed of resilient material 300 capable of repetitive use and bouncing and divided into six (6) specific zones 101-106. Two (2) zones 101, 102 are located at opposed ends of the ball 10 and four (4) zones 103-106 are equally spaced along the remaining sides of the ball. Each of these individual six (6) zones is colored differently and includes a numeral 200 one (1) through six (6). Although this is the preferred configuration, several alternatives in both the number of zones, displayed characters, and shape are anticipated.

In use a user will interact with the ball 10 in an activity and verbally recite a given color, number, or both as the ball 10 approaches. This interaction forces the user to closely focus on the ball 10 to properly identify the given indicator. Overtime, repetitive use of the ball and the provided method will improve the user's hand-eye coordination.

The ball 10 can be provided in several alternate variations to increase or decrease the difficulty level associated with a given task. These changes may include, but not be limited to, the alphanumeric character size can be changed, colors can be altered, the size of the ball 10 can be changed, the texture can be changed, an electrical timer can be embedded into the ball 10 structure, and the shape of the ball 10 can be changed to include such shapes as cubes, discs, and ellipses.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) but that the invention will include all embodiments falling with the scope of the appended claims.

What is claimed is:

1. A object for improved hand-eye coordination exercises, the object comprising:
a plurality of distinct zones; and
an indicator, the indicator placed within each zone, wherein each zone has a unique indicator allowing a user to identify the zone using the indicator.

2. The object as in claim 1, wherein the object is a spherical shaped ball.

3. The object as in claim 1, wherein the indicator is a color.

4. The object as in claim 1, wherein the indicator is an alphanumeric character.

5. The object as is in claim 1, wherein the object includes six distinct zones.

6. The object as in claim 5, wherein two zones are located at opposed ends of the ball and four zones are equally spaced along sides of the ball.

7. The object as in claim 6, wherein the zones have a unique color.

8. The object as in claim 6, wherein the zones have a unique alphanumeric character.

9. The object as in claim 7, wherein the zones have a second indicator with the second indicator a unique alphanumeric character.

10. A ball for improved hand-eye coordination exercises, the ball comprising:
six distinct zones, a first zone located on an end of the ball, a second zone located on a end of the ball opposite the first zone, a third zone, a fourth zone, a fifth zone, and a sixth zone, the third zone, fourth zone, fifth zone, and sixth zone equally spaced along a side of the ball and extending a circumference of the ball; and
an indicator, the indicator placed within each zone, wherein each zone has a unique indicator allowing a user to identify the zone using the indicator.

11. The ball as in claim 9, wherein the indicator is a color.

12. The ball as in claim 9, wherein the indicator is an alphanumeric character.

13. The ball as in claim 10, wherein a second indicator is an alphanumeric character.

14. A method to improve hand-eye coordination of a user, the method comprising:
using a object with distinctly identified zones, with each zone having unique indicators;
throwing the object into air; and
having the user identify the indicator present in the zone closest to them prior to catching the object.

15. A method as in claim 14, wherein the user verbally recites the indicator present in the zone closet to them prior to catching the object.

16. The method as in claim 14, wherein the object is a ball.

17. The method as in claim 16, wherein the object is a ball.
